(19) United States
(12) Patent Application Publication
(10) Pub. No.: US 2018/0039931 A1
(43) Pub. Date: Feb. 8, 2018

(54) SYSTEM, METHOD AND RECORDING MEDIUM FOR RESOLVING CALENDAR CONFLICTS

(71) Applicant: International Business Machines Corporation, Armonk, NY (US)

(72) Inventors: Christopher Ray Dotson, Lexington, KY (US); Nader M. Nassar, Yorktown Heights, NY (US); Annette Suzanne Hoag Riffe, Chelmsford, NY (US); William H. Tworek, Hoplinton, NH (US)

(21) Appl. No.: 15/228,765

(22) Filed: Aug. 4, 2016

(51) Int. Cl. G06Q 10/06; H04L 29/08; G06Q 10/10

(52) U.S. Cl. CPC G06Q 10/063116; G06Q 10/1095; H04L 67/10

(57) ABSTRACT

A calendar conflict resolving method, system, and non-transitory computer readable medium, include processing a request for an event for a time slot of a calendar to correlate the requested event with user data, comparing the requested event with a scheduled event to determine a conflict between the scheduled event and the requested event, and resolving the conflict between the requested event and the scheduled event according to a set of rules, the set of rules being based on the user data.

### BACKGROUND

The present invention relates generally to a calendar conflict resolving method, and more particularly, but not by way of limitation, to a system, method, and recording medium for learning a user's job role, organization, inner circle, job priority, etc. (e.g., social context of user) in order to resolve any calendar conflicts using contextual and social analysis.

Commercial calendar scheduling tools are increasingly being used to schedule meetings. As a result, it is becoming more difficult to manage one's schedule especially with different priority levels of meetings.

Conventional calendar conflict resolving techniques relate to resolving conflicts with a room or a piece of equipment used for a meeting by adjusting the time slots such that the room or piece of equipment is available.

However, needs in the art include the needs to consider priority levels of different types of meetings as well as past user behavior and social context to resolve scheduling conflicts when two meetings are scheduled (or proposed and not yet accepted) for a single time slot.

### SUMMARY

In an exemplary embodiment, the present invention can provide a calendar conflict resolving method, the method including processing a request for an event for a time slot of a calendar to correlate the requested event with user data, comparing the requested event with a scheduled event to determine a conflict between the scheduled event and the requested event, and resolving the conflict between the requested event and the scheduled event according to a set of rules, the set of rules being based on the user data.

One or more other exemplary embodiments include a computer program product and a system.

Other details and embodiments of the invention will be described below, so that the present contribution to the art can be better appreciated. Nonetheless, the invention is not limited in its application to such details, phraseology, teiminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which.

FIG. 1 exemplarily shows a high-level flow chart for a calendar conflict resolving method 100.

FIG. 2 depicts a cloud computing node according to an embodiment of the present invention.

FIG. 3 depicts a cloud computing environment according to an embodiment of the present invention.

FIG. 4 depicts abstraction model layers according to an embodiment of the present invention.

### DETAILED DESCRIPTION

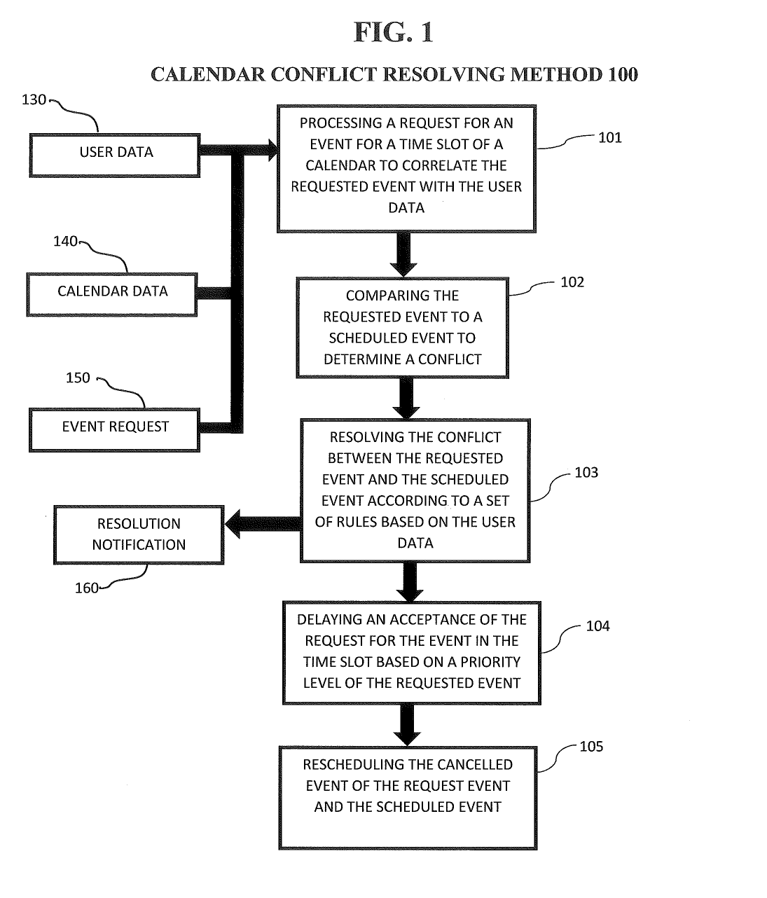

The invention will now be described with reference to FIG. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity.

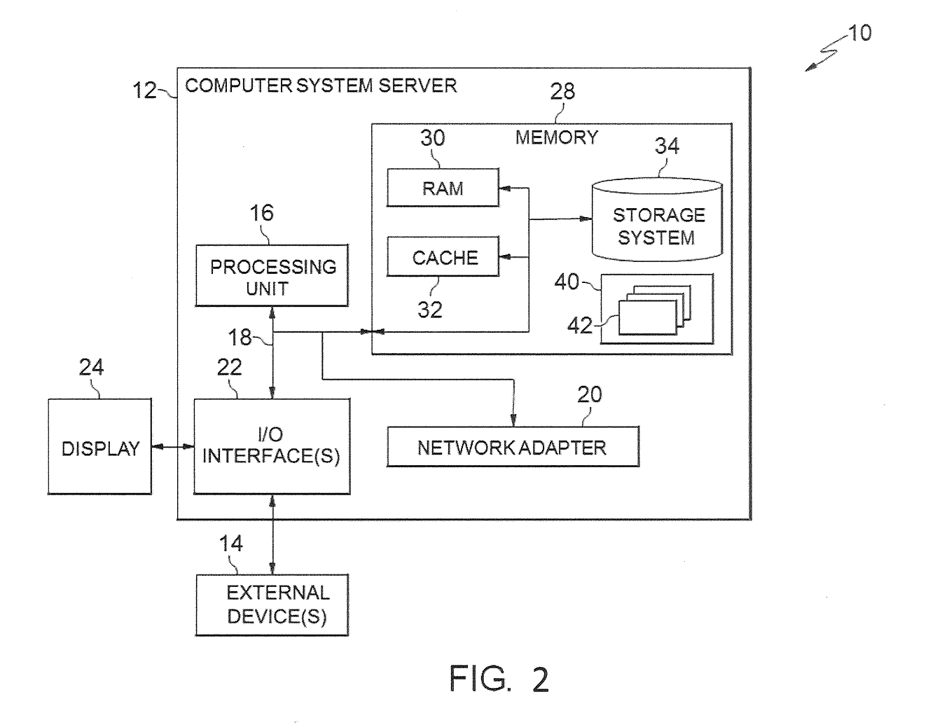

With reference now to the example depicted in FIG. 1, the calendar conflict resolving method 100 includes various steps to learn, for a requested event, a priority level of the requested event based on user data such that the requested event can be compared to a scheduled event for a same time slot and the conflict between the two events can be resolved according to a set of rules based on the user data. That is, the method 100 includes various steps to automatically schedule or re-schedule events based on an importance of the events and learned user data. As shown in at least FIG. 2, one or more computers of a computer system 12 according to an embodiment of the present invention can include a memory 28 having instructions stored in a storage system to perform the steps of FIG. 1.

Thus, the calendar conflict resolving method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

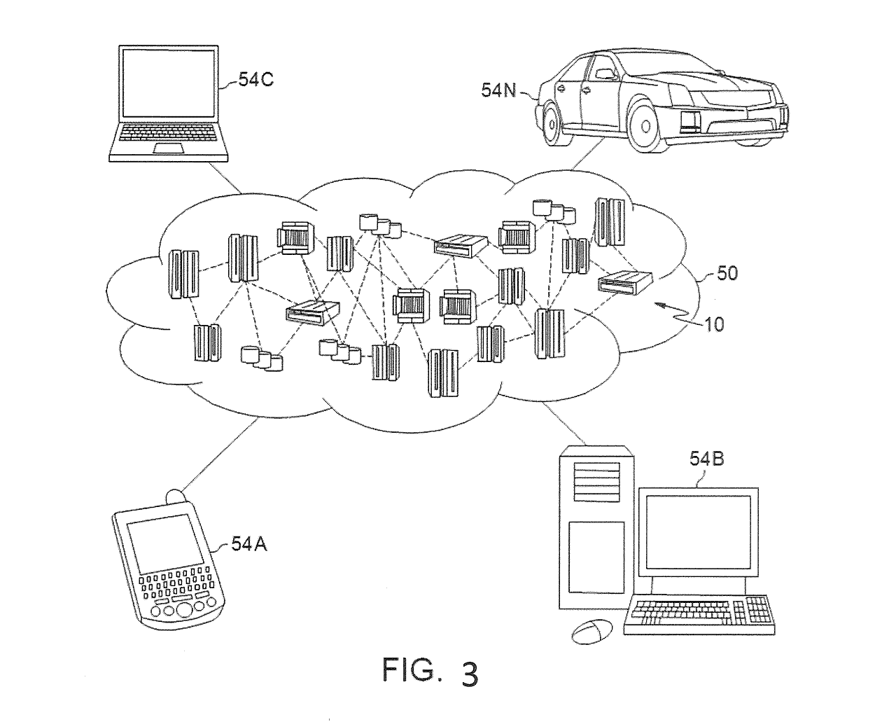

Although one or more embodiments (see e.g., FIGS. 2-4) may be implemented in a cloud environment 50 (see e.g., FIG. 3), it is nonetheless understood that the present invention can be implemented outside of the cloud environment.

In step 101, a request for an event (e.g., an event request 150) for a time slot of a calendar is processed to correlate the requested event with the user data 130. The user data 130 can include, for example, social data such as a user's job role, organization, inner circle, job priority, etc. The user data 130 can also include, for example, past user behaviors such as rescheduling events based on a type of event request. Also, the user data 130 can include calendar data 140 of the user such as if the user is out of town, on a plane, etc. It is noted that each event on the user's calendar is correlated with the user data. That is, the processing processes all events on the user's calendar even if there is found to be no conflict with a scheduled event such that future requested events can be compared.

The event comprises an event that the user would participate in such as a meeting, a scheduled event, a plane flight, a doctor appointment, etc.

In other words, the requested event is processed in step 101 to correlate the user data with the requested event to indicate the likelihood that a user would prioritize the event over another event.

In step 102. a time slot of the requested event is compared with a time slot of a scheduled event to determine if there is a conflict.

In step 103 the conflict between the requested event and the scheduled event is resolved according to a set of rules based on the user data 130. That is, the set of rules determine if the requested event has a higher priority based on the user data to replace (or not replace) the scheduled event on the calendar.

For example, the set of rules can be set based on the user data 130 and comprise prioritizing certain people, such as project colleagues or managers according to the social context of the user's or prior user behavior with regard to those people (e.g., such as ignoring a particular colleague while always prioritizing meetings with manager over every other meeting), prioritizing certain types of event, such as project or department meetings, designating certain events as unavailable to be superseded, such as vacations, doctor appointments, time in transit (e.g., the user will be on a flight and therefore inaccessible), and designating by how much an event must outweigh a scheduled event to supersede it. For example, a priority level to each event can be assigned in step 101 (e.g., on a scale of 1 to 10 with 10 being the highest priority), and the conflict can be resolved in step 103 based on the set of rules including designating that the requested event needs to outweigh the scheduled event by a predetermined number (or amount) such as by “3” on the priority scale in order to justify cancelling (or rescheduling as described later) the scheduled event.

That is, the set of rules can be based on social learning and conflicts can be resolved in step 103 according to past user behavior, machine learning, and contextual analysis (e.g., the user data 130) included in the set of rules.

Also, the set of rules can be based on a defined set of rules for the method including, for example, prioritizing previously accepted events, such that a threshold to supersede a previous commitment (e.g., a previously scheduled event) is higher than a threshold to resolve a conflict between two events received at the same time, prioritizing events of a type that the user has selected to replace events similar to the event in conflict (e.g., if the user has scheduled an informational meeting, and the new event is a site visit from an executive, if the user has in the past replaced such informational meetings with the executive visit, then the system will weight the new event more heavily), de-prioritizing large presentations that are known to have recordings so as to indicate that the user can schedule other events during this time or as a possible time for a reschedule (as described later), de-prioritizing presentations to large groups in general, if they are otherwise not prioritized (e.g., if the user or system has not previously established a weighting for an all-hands meeting, the system will give new events of this type less weight), prioritizing events depending on the organizational position of the requester (e.g., if the user has repeatedly accepted events for department meetings over other types of events such as a request for a project demo comes in from the company CEO that conflicts with a department meeting and although the department meeting has the weighting of repeated occurrences and being selected over other types of events, the set of rules recognizes that the CEO's position in the organization weights this request more heavily), etc.

It is noted that “prioritizing” and “de-prioritizing” can include adjusting a priority level of the requested event or scheduled events such that conflicts or automatically prioritize or de-prioritize events in step 103 can resolve conflicts.

It is further noted that the user is always notified of the resolution in step 103 of a particular conflict, and has the option to override the system's decisions.

That is, the set of rules are more fluid than those of the user (e.g., manual interaction with a calendar to accept/decline events) and evolve throughout the lifetime of the method (e.g., learning the set of rules). If the user changes roles in the company, the method recognizes the change and therefore establishes new priorities for the events associated with that role. If the user starts accepting a particular type of event, indicating a new interest in a topic, the method will weight such events more heavily. If the user overrides several of the method's decisions, the system will recognize this and weight the overridden events less heavily, and give more weight to the type of event the user has selected to accept instead.

In other words, the set of rules can be updated (learned) not only from the specific users' tuning and overriding of calendar acceptance rules, but also from other peer users in the given user's department or similar job roles, or social spheres. For example, if a user is scheduling a meeting, the set of rules can pre-emptively tell the user if his meeting attendees show available in a proposed timeslot, but also how likely the meeting attendees will be to actually accept the meeting based on the contextual and social analysis currently in place for each attendee (e.g., the user data 130 for each attendee).

In step 104, an acceptance of the requested event in a time can be delayed according to a priority level of the requested event being below a predetermined threshold value. For example, if a requested event is historically low on the priority list of events and would be cancelled or rescheduled, the requested event is delayed in step 104 from being accepted even if the time slot is empty. That is, it always looks better to propose a different time than to accept a historically lower priority meeting and then have to reschedule.

In step 105, the scheduled event can be rescheduled if the requested event causes the scheduled event to be cancelled when the conflict is resolved in step 103. For example, the cancelled event can be rescheduled to an open time slot or to a time slot having an event with a lower priority that fits the schedule of both the requester and the user.

In an exemplary embodiment, a first user has a calendar set up. The first user has configured the calendar to accept incoming events if there is no existing conflict. Priority is given to the first user's immediate project members' events, the first user's manager, and project meetings based on the first user data.

Throughout the month, the first user has received several event invitations that have been in conflict with previously accepted events. The first user's new project director came in from out of town and scheduled an all-hands meeting that conflicted with a project status meeting. The first user chose to have the director's meeting supersede the project status meeting. A project design meeting conflicted with a presentation about a new technology that the first user was interested in, but she elected to supersede the presentation with the design meeting. The first user made similar decisions throughout the month and all were noted in the calendar system.

Initially, the method 100 was able to resolve conflicts only based on the manual configuration that the first user set up, but now that she has made some decisions to have scheduled events overridden by incoming events, the method 100 can make more intelligent decisions on its own. The first user has a monthly one-on-one scheduled with her manager. When a conflicting event invitation for an update meeting about a corporate event comes in, the method 100 determines that the one-on-one is more important. When she receives an invitation for a product meeting that conflicts with a presentation about the company's quarterly results, the method 100 supersedes the presentation with the meeting.

The first user is notified about the method 100 decisions and has the choice to override them. For example, she has a daily status call about her project, and receives an invitation to a site visit from the corporate CEO. The method 100 prioritizes the project meeting, but The first user decides that it's more important to attend the CEO's presentation since this is a rare occurrence. The method 100 incorporates this information into its rules for future use.

Thus, some embodiments of the invention have realized an exemplary technical solution to one of the technical needs in the art by learning social, contextual, user behavior, etc. (e.g. user data) in order to automatically resolve conflicts between a scheduled event and a newly requested event based on a set of customizable rules, thus removing the need for humans to exhaustively manage their own calendars to determine the importance of certain meetings in order to have an optimally scheduled calendar. Therefore, the technical solutions may provide significantly more than the conventional techniques that require extensive human management (e.g., costs associated with managing scheduling) by removing the need for human management because the method can learn the humans predicted course of action for the events based on a social analysis, contextual data, past user behavior, etc.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 2, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforins and/or software as services for which a cloud consumer does not need to maintain resources on a local computing circuit. It is understood that the types of computing circuits 54A-N shown in FIG. 3 are intended to be illustrative only and that computing nodes 10 and cloud computing environment 50 can communicate with any type of computerized circuit over any type of network and/or network addressable connection (e.g., using a web browser).

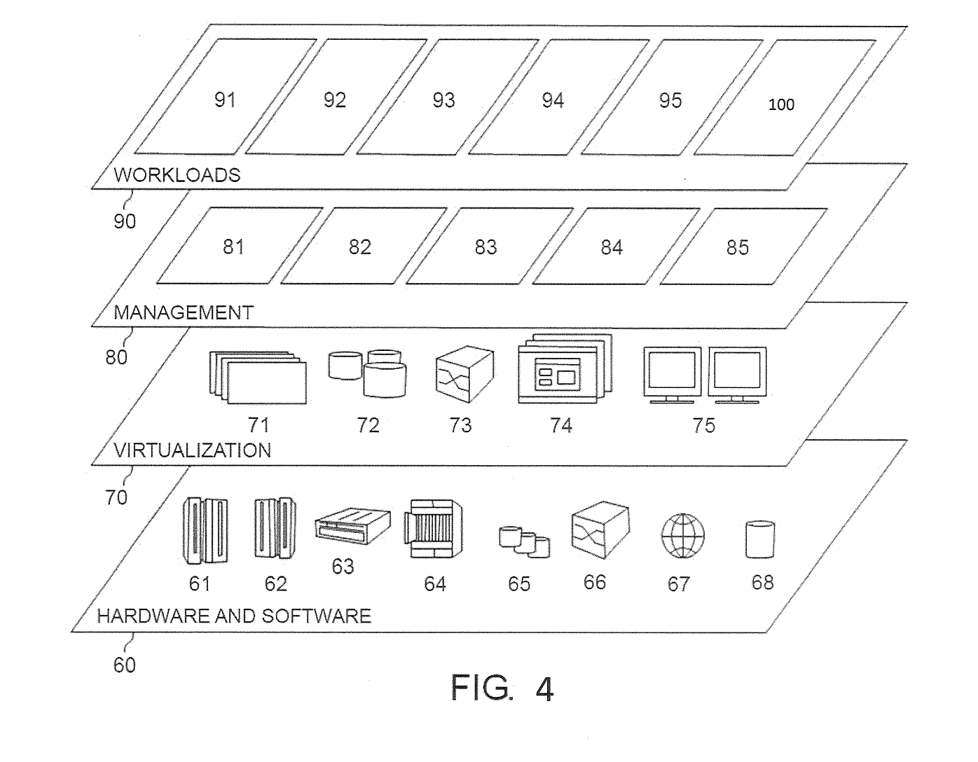

Referring now to FIG. 4, an exemplary set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the calendar conflict resolving method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented calendar conflict resolving method, the method comprising:
processing a request for an event for a time slot of a calendar to correlate the requested event with user data;
comparing the requested event with a scheduled event to determine a conflict between the scheduled event and the requested event; and
resolving the conflict between the requested event and the scheduled event according to a set of rules, the set of rules being based on the user data.

2. The computer-implemented method of claim 1, wherein the user data is selected from a group consisting of:
social data of the user;
contextual data of the user and the user's calendar;
past behavior of the user; and
past behavior by past users.

3. The computer-implemented method of claim 1, wherein the set of rules determines if the requested event has a higher priority based on the user data to at least one of cancel and replace the scheduled event.

4. The computer-implemented method of claim 1, wherein the set of rules comprises a rule for prioritizing the requested event over the scheduled event according to social context data of the user data if the requested event is sent by a particular person.

5. The computer-implemented method of claim 1, wherein the set of rules comprises a rule for prioritizing the requested event over the scheduled event according to past user behavior of the user data related to past user interactions with an entity included in the requested event.

6. The computer-implemented method of claim 1, wherein the set of rules comprises a rule for prioritizing the requested event over the scheduled event based on the requested event being a particular type of event.

7. The computer-implemented method of claim 1, where the processing further processes the requested event to assign a priority level to the requested event, and
wherein the set of rules comprises a rule for prioritizing the requested event over the scheduled event based on the priority level of the requested event being greater than a priority level of the scheduled event by a predetermined threshold.

8. The computer-implemented method of claim 1, wherein the set of rules comprises a rule for prioritizing a previously accepted event such that a threshold to cancel the previously accepted event is higher than a threshold to resolve a conflict between a plurality of new unaccepted event requests.

9. The computer-implemented method of claim 1, wherein the set of rules comprises a rule for prioritizing the requested event over the scheduled event if a type of the requested event is similar to a type event that the user has manually selected to replace the scheduled event in conflict.

10. The computer-implemented method of claim 1, wherein the set of rules comprises a rule for de-prioritizing the requested event if the requested event includes a recording of the event.

11. The computer-implemented method of claim 1, wherein the set of rules comprises a rule for de-prioritizing the requested event if the requested event includes a number of invitees greater than a predetermined threshold value.

12. The computer-implemented method of claim 1, wherein the set of rules comprises a rule for prioritizing the requested event based on an organizational position of the requester of the requested event.

13. The computer-implemented method of claim 1, further comprising delaying an acceptance of the requested event in the time slot if there is no conflict when a priority level of the requested event is less than a predetermined threshold value that is defined in the set of rules.

14. The computer-implemented method of claim 1, further comprising rescheduling the scheduled event if the resolving resolves the conflict by cancelling the scheduled event.

15. The computer-implemented method of claim 2, wherein the set of rules is based on learning rules to resolve conflicts according to an analysis of at least one of the past behavior of the user, the social data of the user, the past behavior by past users, and the contextual data.

16. The computer-implemented method of claim 13, further comprising rescheduling the scheduled event if the resolving resolves the conflict by cancelling the scheduled event.

17. The computer-implemented method of claim 1, embodied in a cloud-computing environment.

18. A computer program product for calendar conflict resolving, the computer program product comprising a computer readable storage medium having program instructions embodied therewith, the program instructions executable by a computer to cause the computer to perform:
processing a request for an event for a time slot of a calendar to correlate the requested event with user data;
comparing the requested event with a scheduled event to determine a conflict between the scheduled event and the requested event; and
resolving the conflict between the requested event and the scheduled event according to a set of rules, the set of rules being based on the user data.

19. A calendar conflict resolving system, said system comprising:
a processor; and
a memory, the memory storing instructions to cause the processor to:
processing a request for an event for a time slot of a calendar to correlate the requested event with user data;
comparing the requested event with a scheduled event to determine a conflict between the scheduled event and the requested event; and
resolving the conflict between the requested event and the scheduled event according to a set of rules, the set of rules being based on the user data.

20. The system of claim 19, embodied in a cloud-computing environment.
